(19) United States
(12) Patent Application Publication
(10) Pub. No.: US 2010/0001856 A1
(43) Pub. Date: Jan. 7, 2010

(54) LUGGAGE IDENTIFICATION AND FINDER WITH CONTINUOUS RADIO FREQUENCY FEED SYSTEM

(76) Inventor: Sheldon Bender, Delray Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/393,064

(22) Filed: Feb. 26, 2009

Related U.S. Application Data
(60) Provisional application No. 61/133,601, filed on Jul. 1, 2008.

(51) Int. Cl. G08B 1/08

(52) U.S. Cl. 340/539.11

(57) ABSTRACT

Embodiments of the present invention address deficiencies of the art in respect to luggage location and provide a system for luggage identification and location through a continuous RF feed. In an embodiment of the invention, a luggage location system can include a luggage transceiver and a handheld transceiver. The luggage transceiver can include an RF receiver and an RF transmitter, both coupled to a power source, and a trigger powered by the power source and coupled to the RF receiver and the RF transmitter. The trigger can include circuitry enabled to direct an emission of an RF return signal in response to detecting receipt of a continuous RF signal in the RF transmitter from the handheld transceiver. By comparison, the handheld transceiver can include an RF receiver and an RF transmitter, both coupled to a power source, an on/off switch that when in an on position permits the RF transmitter to emit a continuous RF signal, and an alert sub-system coupled to the RF receiver and configured to activate at least one of an audio alert and a visible alert responsive to detecting receipt of the RF return signal from the luggage transceiver

### CROSS-REFERENCE TO RELATED APPLICATIONS

This patent application claims the benefit under 35 U.S.C. §120 as a continuation-in-part of presently pending U.S. Provisional Patent Application 61/133,601, filed on Jul. 1, 2008 entitled LUGGAGE IDENTIFICATION AND FINDER WITH CONTINUOUS RADIO FREQUENCY FEED SYSTEM, the entire teachings of which are incorporated herein by reference.

### BACKGROUND OF THE INVENTION

1. Field of the Invention

The present invention relates to the field of luggage location and more particularly to transmitter-receiver pairs configured to identify luggage from a distance.

2. Description of the Related Art

Luggage has formed part and parcel of travel since the dawn of civilization. Early forms of travel enjoyed by only a few permitted people to remain close in proximity to their luggage throughout travel. However, mass transportation including rail, bus and air travel often necessitates the physical separation of traveler and luggage during the course of travel. Thus, entire technologies such as baggage handling conveyer belts and luggage tracking systems, along with entire organizational entities including baggage handlers have been created to address the problem of reuniting traveler with luggage subsequent to travel. Even still, it remains commonplace globally for travelers to lose luggage. A primary cause of lost luggage remains that of mistaken identity where one traveler mistakes luggage of another as their own.

To combat the case of mistaken identity, travelers often mark luggage with unique identification tags, brightly colored ribbons and the like. More sophisticated accessories provide for the audible and visual notification of the proximity of luggage through the combination of a handheld transmitter activating an audible and visual alert disposed in a receiver attached to luggage. By way of example, U.S. Pat. No. 6,147,602 to Sheldon Bender issued on Nov. 14, 2000 (the “'602 patent”) claims a luggage locator with both a transmitter unit and a receiver unit. The transmitter unit transmits a radio-frequency (RF) signal so long as a push button in the transmitter unit remains depressed. Upon receipt of which in the receiver unit, a light element in the receiver unit becomes illuminated. As will be apparent from the '602 patent, to activate the light element, the traveler must continuously depress a button in the transmitter unit which can be irritating from a human factors perspective.

### BRIEF SUMMARY OF THE INVENTION

Embodiments of the present invention address deficiencies of the art in respect to luggage location and provide a novel and non-obvious system for luggage identification and location through a continuous RF feed. In an embodiment of the invention, a luggage location system can include a luggage transceiver and a handheld transceiver. The luggage transceiver can include an RF receiver and an RF transmitter, both coupled to a power source, and a trigger powered by the power source and coupled to the RF receiver and the RF transmitter. The trigger can include circuitry enabled to direct an emission of an RF return signal in response to detecting receipt of a continuous RF signal in the RF transmitter from the handheld transceiver. By comparison, the handheld transceiver can include an RF receiver and an RF transmitter, both coupled to a power source, an on/off switch that when in an on position permits the RF transmitter to emit a continuous RF signal, and an alert sub-system coupled to the RF receiver and configured to activate at least one of an audio alert and a visible alert responsive to detecting receipt of the RF return signal from the luggage transceiver.

In one aspect of the embodiment, the luggage transceiver can be embedded in an article of luggage as part of the article of luggage. For instance, the luggage transceiver can be embedded in an article of luggage as part of a handle for the article of luggage. Alternatively, the luggage transceiver can be embedded in an article of luggage as part of a luggage frame for the article of luggage. In another aspect of the embodiment, the luggage transceiver can include both a sleep mode and an active mode, the sleep mode powering only the trigger and the RF receiver and the active mode powering each of the trigger, the RF receiver and the RF transmitter.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a luggage location system configured for luggage identification and location through a continuous RF feed;

FIG. 2 is a block diagram illustrating a transceiver pair configured for luggage identification and location through a continuous RF feed; and,

FIG. 3 is a flow chart illustrating a process for luggage identification and location through a continuous RF feed.

### DETAILED DESCRIPTION OF THE INVENTION

Embodiments of the present invention provide a system for luggage identification and location through a continuous RF feed. In accordance with an embodiment of the present invention, a luggage transceiver unit associated with an article of luggage can be configured with both an RF receiver and an RF transmitter. Both the RF receiver and the RF transmitter in the luggage transceiver unit can be coupled to a battery power source operable in an active mode and in a sleep mode. In the active mode, the RF receiver and the RF transmitter can be powered for operation. In the sleep mode, only the RF receiver need be powered to detect the receipt of an RF signal meeting a pre-selected criteria such as frequency or data embedded in the RF signal. The luggage transceiver unit further can include trigger logic enabled upon detecting the receipt of the RF signal meeting the pre-selected criteria to enter the active mode and transmit a return RF signal.

The handheld transceiver unit in turn can be configured with an RF transmitter coupled to a battery power source. The handheld transceiver unit can include and an on/off switch, such as a slide-switch, so as to permit the transmission of an RF signal when in an on position, and to inhibit transmission of the RF signal when in an off position. The handheld transceiver unit further can be configured with an RF receiver coupled to the power source and enabled to receive a return RF signal from the luggage transceiver unit. Even yet further, the handheld transceiver unit can include an alert sub-system coupled to the RF receiver. The alert sub-system can include both a visual element such as a light emitting diode (LED) or an array of LEDs, and an audible element such as a piezoelectric sound generator. A trigger can be coupled to the RF receiver and the alert sub-system and enabled to trigger the alert sub-system upon detecting acquisition of the return RF signal from the luggage transceiver unit. In this way, upon activating the on/off switch, luggage to which the receiver unit has been affixed can be located without requiring a tedious depression of a push button on the transmitter unit.

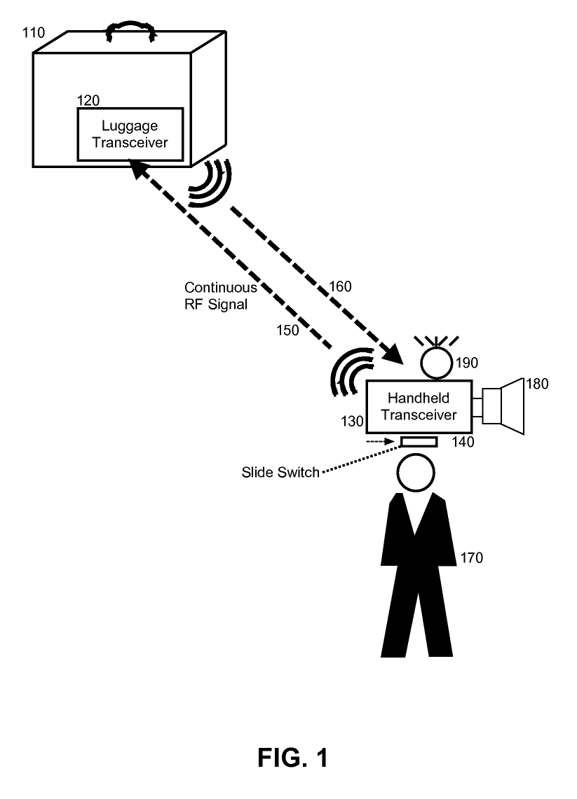

In further illustration, FIG. 1 pictorially depicts a luggage location system configured for luggage identification and location through a continuous RF feed. As shown in FIG. 1, a traveler 170 can hold a handheld transceiver 130 paired for communication with a luggage transceiver 120 disposed within an article of luggage 110 corresponding to the traveler 170. The luggage transceiver 120 can be coupled to the exterior of the article of luggage 110 by way of a strap or cord, but preferably the luggage transceiver 120 is disposed within the article of luggage 110 or embedded into the article of luggage 110 as part of the article of luggage 110, for instance as part of the frame, body, handle or included under the outer shell of the article of luggage 110. The traveler 170 can activate the handheld transceiver 130 by way of an on/off switch 140 such as a slide switch.

In response to the activation of the handheld transceiver 130, a continuous RF signal 150 can be transmitted by the handheld transceiver 130 and received by the luggage transceiver 120. The luggage transceiver 120, in response to detecting the continuous RF signal 150, can respond by transmitting a return RF signal 160 to be received by the handheld transceiver 130. Optionally, the luggage transceiver 120, in response to detecting the continuous RF signal 150 can emit either or both of a visible light (by way of a blinking LED, for instance) or an audible sound (neither feature of which is shown in the illustration). The receipt of the return RF signal 160 by the handheld transceiver 130 can trigger different alerts such as a visible alert 190, an audible alert 180, or both. In this way, the traveler 170 can be alerted to the presence of the article of luggage 110 without continuously depressing a transmit button. Further, to the extent that the luggage transceiver 120 is disposed within the article of luggage 110, the placement of the alerts in the handheld transceiver 130 can better alert the traveler 170 of the presence of the article of luggage 110 without requiring the traveler 170 to visibly detect an alert provided on the article of luggage 110 which may be a great distance away from the traveler 170 at the time of the alert.

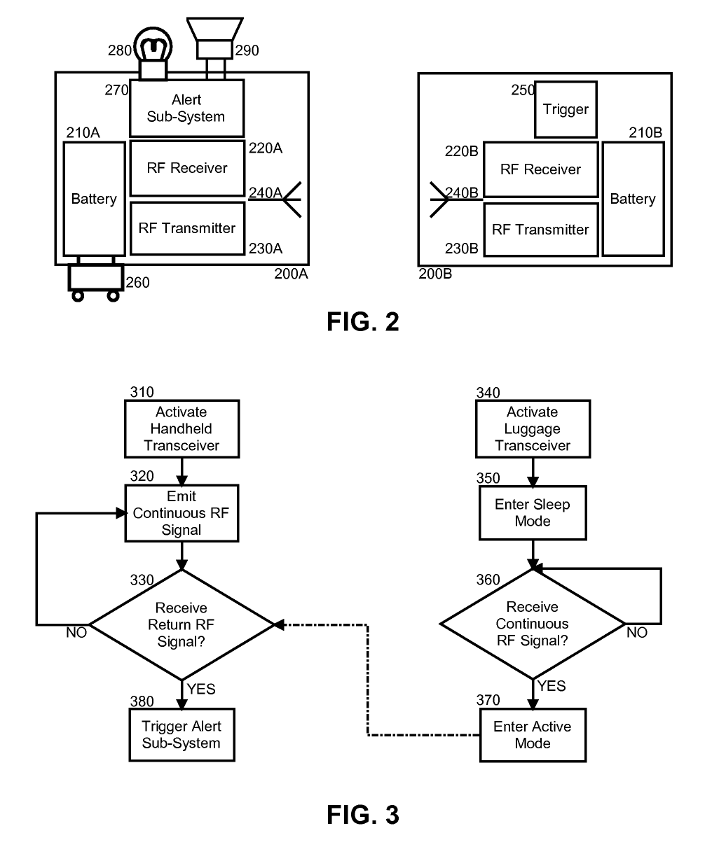

In further illustration, FIG. 2 is a block diagram illustrating a transceiver pair for luggage identification and location through a continuous RF feed. The transceiver pair can include both a handheld transceiver 200A and a luggage transceiver 200B. The handheld transceiver 200A can be sized to fit in the hand of a traveler and can include an RF receiver 220A, an RF transmitter 230A and an antenna 240A coupled to both the RF receiver 220A and the RF transmitter 230A, though it is to be recognized that separate antennae can be provided for each of the RF receiver 220A and the RF transmitter 230A. Both the RF receiver 220A and the RF transmitter 230A (which can include separate circuitry, or can be integrated as one circuit block) can be powered by battery 210A and power to the RF transmitter 230A can be switched on and off by operation of on/off switch 260. Of note, the RF transmitter 230A can be configured upon activation to emit a continuous RF signal of specified frequency and, optionally, specified data content carried by the RF signal.

An alert sub-system 270 can be coupled to the battery 210A and the RF receiver 220A. The alert sub-system 270 can include circuitry configured to detect the receipt of a return RF signal in the RF receiver 270 and to respond thereto by activating either or both of a visible alert and an audible alert. The activation of the visible alert can result in the energization of lamp 280 (for instance an LED or LED array). The activation of the audible alert can result in the energization of sound source 290 such as a piezoelectric speaker, and the like. In either case, a traveler holding the handheld transceiver 200A can become alerted to the proximity of luggage with the luggage transceiver 200B by way of the alert sub-system 270.

Like the handheld transceiver 200A, the luggage transceiver 200B can include an RF receiver 220B, an RF transmitter 230B (which can include separate circuitry, or can be integrated as one circuit block) and an antenna 240B coupled to both the RF receiver 220B and the RF transmitter 230B, though again it is to be recognized that separate antennae can be provided for each of the RF receiver 220B and the RF transmitter 230B. Both the RF receiver 220B and the RF transmitter 230B can be powered by battery 210B. A trigger 250 further can be coupled to the RF receiver 220B and the RF transmitter 230B and can be powered by the battery 210B. The trigger 250 can include circuitry enabled to detect the receipt of a continuous RF signal from the RF transmitter 230A in the RF receiver 220A. The trigger 250 further can include circuitry enabled to activate the RF transmitter 230B to transmit a return RF signal to the handheld transceiver 200A.

In yet further illustration of the operation of the pair of transceivers 200A, 200B, FIG. 3 is a flow chart illustrating a process for luggage identification and location through a continuous RF feed. Beginning in block 310, the handheld transceiver can be activated by operation of an on/off switch such as a slide switch. In block 320, a continuous RF signal can be emitted from the handheld transceiver and in block 330 it can be determined whether or not a return RF signal has been received.

Separately, in block 340 the luggage transceiver can be activated by operation of an on/off switch—generally before initiating travel and separating from the luggage. In block 350, the luggage transceiver can enter a sleep mode in which the RF receiver of the luggage transceiver can be remain powered as can trigger 250. In decision block 360, if a continuous RF signal is detected to have been received in the RF receiver of the luggage transceiver, in block 370 the luggage transceiver can enter an active mode in which the RF transmitter is powered and a return RF signal emitted.

In decision block 330, if it is determined that a return RF signal has been received by the RF receiver of the handheld transceiver, in block 380 the alert sub-system can be triggered to activate either or both of an audible alert and a visible alert. In this way, the traveler holding the handheld transceiver can be alerted to the proximity of the luggage with the luggage transceiver without first having to visibly spot the luggage from a distance and without having to expose the luggage transceiver as an external appendage to the luggage. Yet further, in that the luggage transceiver need not be appended to the exterior of the luggage, the luggage transceiver can be embedded into or incorporated as part of the construction of the luggage, for instance the luggage transceiver can be included in the framing of the luggage, as part of the strapping of the luggage, or as part of the handle of the luggage.

I claim:

1. A luggage location system comprising:
a luggage transceiver; and,
a handheld transceiver;
the luggage transceiver comprising an radio frequency (RF) receiver and an RF transmitter, both coupled to a power source, and a trigger powered by the power source and coupled to the RF receiver and the RF transmitter, the trigger comprising circuitry enabled to direct an emission of an RF return signal in response to detecting receipt of a continuous RF signal in the RF transmitter from the handheld transceiver;
the handheld transceiver comprising an RF receiver and an RF transmitter, both coupled to a power source, an on/off switch that when in an on position permits the RF transmitter to emit a continuous RF signal, and an alert sub-system coupled to the RF receiver and configured to activate at least one of an audio alert and a visible alert responsive to detecting receipt of the RF return signal from the luggage transceiver.

2. The luggage locator of claim 1, wherein the luggage transceiver is embedded in an article of luggage as part of the article of luggage.

3. The luggage locator of claim 1, wherein the luggage transceiver is embedded in an article of luggage as part of a handle for the article of luggage.

4. The luggage locator of claim 1, wherein the luggage transceiver is embedded in an article of luggage as part of a luggage frame for the article of luggage.

5. The luggage locator of claim 1, wherein the luggage transceiver comprises both a sleep mode and an active mode, the sleep mode powering only the trigger and the RF receiver and the active mode powering each of the trigger, the RF receiver and the RF transmitter.

6. The luggage locator of claim 1, wherein the on/off switch is a slide switch.

7. The luggage locator of claim 1, wherein the power source for the luggage transceiver is a battery and wherein the power source for the handheld transceiver is a battery.

8. An article of luggage comprising:
a luggage body;
a luggage transceiver embedded in the luggage body; and,
a handheld transceiver;
the luggage transceiver comprising an radio frequency (RF) receiver and an RF transmitter, both coupled to a power source, and a trigger powered by the power source and coupled to the RF receiver and the RF transmitter, the trigger comprising circuitry enabled to direct an emission of an RF return signal in response to detecting receipt of a continuous RF signal in the RF transmitter from the handheld transceiver;
the handheld transceiver comprising an RF receiver and an RF transmitter, both coupled to a power source, an on/off switch that when in an on position permits the RF transmitter to emit a continuous RF signal, and an alert sub-system coupled to the RF receiver and configured to activate at least one of an audio alert and a visible alert responsive to detecting receipt of the RF return signal from the luggage transceiver.

9. An article of luggage comprising:
a luggage body and a luggage handle coupled to the luggage body;
a luggage transceiver embedded in the luggage handle; and,
a handheld transceiver;
the luggage transceiver comprising an radio frequency (RF) receiver and an RF transmitter, both coupled to a power source, and a trigger powered by the power source and coupled to the RF receiver and the RF transmitter, the trigger comprising circuitry enabled to direct an emission of an RF return signal in response to detecting receipt of a continuous RF signal in the RF transmitter from the handheld transceiver;
the handheld transceiver comprising an RF receiver and an RF transmitter, both coupled to a power source, an on/off switch that when in an on position permits the RF transmitter to emit a continuous RF signal, and an alert sub-system coupled to the RF receiver and configured to activate at least one of an audio alert and a visible alert responsive to detecting receipt of the RF return signal from the luggage transceiver.
